(19) United States
(12) Patent Application Publication
(10) Pub. No.: US 2007/0189270 A1
(43) Pub. Date: Aug. 16, 2007

(54) Network adapter

(76) Inventors: Daniel M. Borislow, Palm Beach, FL (US); Gregory Lynn Wood, Signal Mountain, TN (US)

Correspondence Address: ARNOLD & PORTER LLP;ATTN: IP DOCKETING DEPT., 555 TWELFTH STREET, N.W., WASHINGTON, DC, 20004-1206, US

(21) Appl. No.: 11/353,958

(22) Filed: Feb. 15, 2006

(51) Int. Cl. H04L 12/66

(52) U.S. Cl. 370/352

(57) ABSTRACT

The claimed invention consists of integrating a wireless client with a network adapter in a single device which allows a telephone to connect to a network access point for the purpose of establishing Voice over IP (VoIP) calls. The user can attach his telephone to the network adapter and place it anywhere within range of a wireless network and not be required to connect to a wired network via a cable. This allows the end user to place the network adapter and phone in a place without the restrictions of wires. Also, the network adapter could be used to transmit voice data over a broadband link and to transmit emergency calls over a cellular network.

### FIELD OF THE INVENTION

This invention is in the field of Voice over Internet Protocol (VoIP) communications and, more particularly, in the field of systems and methods of interfacing a standard telephone to a VoIP compatible communication network over an existing wireless network.

### BACKGROUND OF THE INVENTION

VoIP is a technology that allows the systems and transmission channels that connect computer networks to act as an alternative to phone lines, delivering real-time voice to both standard telephones and personal computers (PCs). VoIP allows an individual to utilize a network connection to transmit voice encapsulated data packets over available local communication lines, such as the Internet. This is typically facilitated by the use of an Analog Telephone Adapter (ATA) which emulates some functions of a phone company's central office and connects via a wired interface to a network like the Internet.

In a VoIP system, the analog voice signal is typically picked up by a microphone and sent to an audio processor within a personal computer. In the computer, either a software or hardware CODEC performs analog-to-digital conversion and compression. Considerable research has been devoted to voice compression schemes that are well know to those skilled in the art. The nominal bandwidth required for telephone-type voice ranges from 2.9 Kbps (RT24 by Voxware) to 13 Kbps (GSM cellular standard).

In placing the CODEC output into packets, there is a trade-off between bandwidth and latency. CODECs do not operate continuously. Instead, they sample the voice over a short period of time, known as a frame. These frames are like little bursts of data. One or more frames can be placed in a single IP datagram or packet, and then the packet payload is wrapped in the necessary packet headers and trailers. This packet overhead is at least 20 bytes for IP and 8 bytes for the User Datagram Protocol (UDP). Layer 2 protocols add even more overhead. Waiting longer to fill the IP datagram reduces overall overhead, which in turn reduces the true bandwidth needed to send the digitized voice. However, this waiting creates latency at the source, and too much total latency makes for a difficult conversation.

The total network latency and jitter (changes in the latency) have a degrading effect upon voice quality. Therefore, real-time voice quality is difficult to maintain over a large wide-area packet network without priority handling. As previously mentioned, VoIP converts standard telephone voice signals into compressed data packets that can be sent locally over an Ethernet or globally via an ISP's data networks rather than traditional phone lines. One of the main difficulties with VoIP connections is that the communication network supporting a VoIP platform must be able to recognize that VoIP data packets contain voice signals, and be “smart” enough to know that the communication network has to move the data packets quickly.

Presently, most VoIP voice traffic does not use the public Internet but runs on private IP-based global networks that can deliver voice data with minimal congestion. As such, transmission of voice signals over private data networks offers businesses some great advantages. For ISPs, merging voice and data on one single network allows them to expand their services beyond simple information access and into the realm of voice, fax, and virtual private networking. For businesses, the benefit is big savings on long-distance service. The Internet right now is a free medium on many networks. If businesses can send voice over a computer network, businesses can conceivably make long-distance or international calls for the cost of a local call. VoIP further facilitates electronic commerce by allowing a customer service representative using one data line to answer telephone questions while simultaneously placing a customer's order online, perusing the company's web site, browsing an online information/product database, or sending an E-mail. Similarly, VoIP also creates new possibilities for remote workers, who for the cost of a local call can log in remotely, retrieve voice mail from their laptop PCs, and keep their E-mail and web applications running while conducting multiple voice and data calls over one phone line. Presently, this type of expanded VoIP functionality is exclusively limited to those with access to private IP based networks, such as business users and not the typical household user.

In fact, most household computer users are generally limited to the congested public Internet and cannot implement the VoIP standard effectively. If latency and jitter are too high, or the cost of reducing them is excessive, one alternative is to buffer the CODEC data at the receiver. A large buffer can be filled irregularly but emptied at a uniform rate. This permits good quality reproduction of voice. Such a buffering technique is known as audio streaming, and it is a very practical approach for recorded voice or audio. Unfortunately, excessive buffering of the audio signals leads to generally unacceptable one-sided telephone conversations, where one party dominates the transmissions.

Traditionally, the operating environment for a household user with a VoIP connection is either a laptop or desktop general-purpose computer. The recording and transmission or interpretation of the VoIP packets takes place in the sound system or modem DSP found on the laptop or desktop. As such, the desktop system has a minor advantage over the laptop, because the desktop sound system traditionally provides stereo surround speakers and an accurate microphone. Thus, the desktop system can more accurately capture an individual's voice for retransmission of these voice signals to the user on the other end of the connection. VoIP telephone software buffering and control structures help improve the connection, but even though the audio signal has been accurately sampled, the processor delays and transmission latency associated with the desktop VoIP connection over the public Internet tends to result in a barely audible VoIP call. One of the main difficulties with using VoIP in a household system is that the ATA has to be connected to the network access device via a wired connection and thus limits the placement of the phone.

The present invention solves these and other problems involved in the current state of the art, as will be explained below.

### SUMMARY OF THE INVENTION

The systems and methods disclosed herein also solve the other problems alluded to above by allowing the network adapters to connect to a wireless network and thereby to a VoIP carrier via a signaling protocol. The limitations of the prior art are thus overcome and additional freedom and functionality are provided the user, as described in more detail below.

Optionally, the network adapter can also be configured to transmit information over a broadband cellular link, such as EV-DO or other similar types of networks.

The disclosed network adapter may also include software which allows the user to overcome problems associated with making emergency calls on a VoIP communications network. The central processing unit in the network adapter can also include the ability to route emergency calls to a commercial mobile radio service (“CMRS” or cellular) transmitter over a CMRS network.

Additional objects, advantages and novel features of this invention will be set forth in part in the description that follows, and in part will become apparent to those skilled in the art upon examination of the following, or may be learned by practicing the invention.

### BRIEF DESCRIPTION OF THE DRAWINGS

In the accompanying drawings that form a part of the specification and are to be read in conjunction therewith, the present invention is illustrated by way of example and not limitation, with like reference numerals referring to like elements, wherein:

FIG. 1 illustrates a network adapter, according to an embodiment of the invention;

FIG. 2(a) illustrates a communications network, according to an embodiment of the invention;

FIG. 2(b) illustrates a communications network, according to another embodiment of the invention;

FIG. 3(a) is a flow chart illustrating the process of making an out-bound call, according to an embodiment of the invention;

FIG. 3(b) is a continuation of a flow chart illustrating the process of making an out-bound call, according to an embodiment of the invention;

FIG. 4 is a flow chart illustrating the conclusion of a VoIP voice call, according to an embodiment of the invention;

FIG. 5 is a flow chart illustrating the beginning of a VoIP voice call, according to an embodiment of the invention;

FIG. 6 is a flow chart illustrating the beginning of a PSTN voice call, according to an embodiment of the invention; and

FIG. 7 is a flow chart illustrating the process of making an emergency call, according to an embodiment of the invention.

### DETAILED DESCRIPTION OF THE INVENTION

In the following detailed description, numerous specific details are set forth in order to provide a thorough understanding of the invention. In other instances, well known structures, interfaces, and processes have not been shown in detail in order not to unneccessarily obscure the invention. However, it will be apparent to one of ordinary skill in the art that those specific details disclosed herein need not be used to practice the invention and do not represent a limitation on the scope of the invention, except as recited in the claims. It is intended that no part of this specification be construed to effect a disavowal of any part of the full scope of the invention.

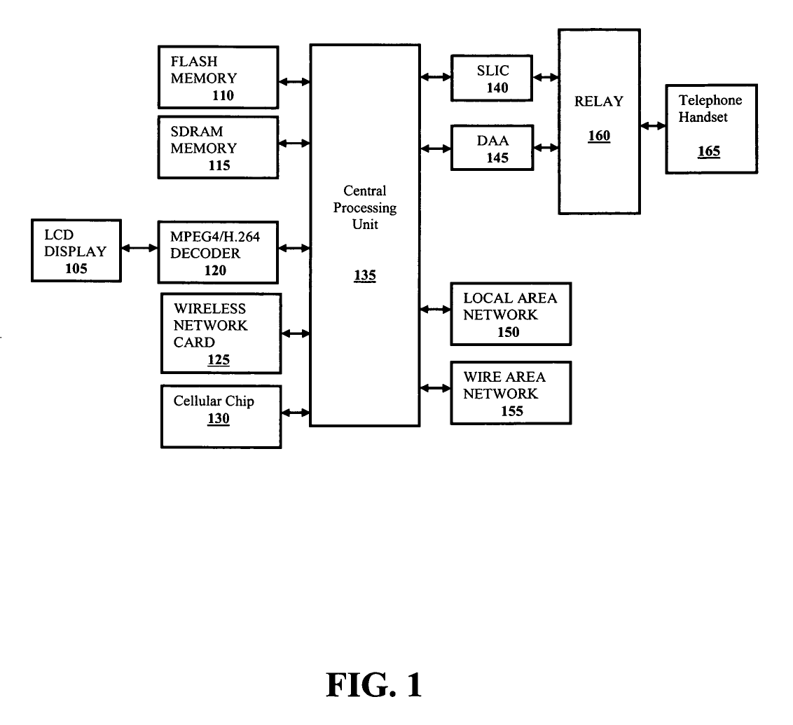

FIG. 1 illustrates the components of a particular device, which is a network adapter 100, according to an embodiment of the invention.

The network adapter 100 includes a central processing unit 135 connected to the relay 160 via the SLIC 140 and the DAA 145. The relay 160 is used to isolate and bridge an analog telephone handset (165) to a public switched telephone network (PSTN).

As stated above, the network adapter 100 includes a subscriber line interface (SLIC) 140 and a data access arrangement (DAA) circuit 145. The SLIC 140 is responsible for emulating a central office. It generates a ring current, detects on-hook and off-hook transition and notifies the central processing unit (CPU) 135 of any signal transition. The SLIC 140 also performs A/D conversion on input voice signal and D/A conversion on voice signal to be processed by the telephone handset (165). The DAA 145 detects a ring current and notifies the CPU 135 of the presence of a ring current. The DAA 145 also creates off-hook and on-hook transactions in order to emulate a telephone handset back to the phone company's central office, and it also performs A/D and D/A conversion on signals transmitting to and from the central office (not shown).

The CPU 135 controls the network adapter 100 via programmable software. The CPU 135 is a microprocessor, of a kind that is well known to one of ordinary skill in the art. Integrated into the CPU 135 is a digital signal processor software (not shown) which processes voice signal data in real time.

Connected to the CPU 135 are several memory devices, flash memory 110 and SDRAM 115. The flash memory 110 is used as a working storage for the CPU 135 during operation. The SDRAM 115 is used to store information permanently, such as configuration information and program code, when the network adapter 100 is turned off.

The MPEG-4/H.264 decoder 120 is an integrated circuit that is responsible for producing video output from the CPU 135 to the LCD Display 105. The MPEG-4/H.264 decoder 120 decodes streaming video information received via the wide area network connection 155 via the CPU 135. One of ordinary skill in the art can appreciate that any kind of MPEG-4/H.264 decoder can used to decode the video output.

The LCD Display 105 is used to display information about the incoming call and diagnostic and status information of the network adapter 100. The LCD Display 105 can also be used to display and present advertising and entertainment to the user. In an alternative embodiment of the invention, the CPU 135 includes circuity which monitors the signal strength of the wireless network (not shown) employed by the network adapter 100. The signal strength monitoring circuity is well known to one of ordinary skill in the art. The MPEG-4/H.264 decoder 120 receives this information from the CPU 135 in real-time and transfers this information to the LCD Display 105. The LCD Display 105 receives the signal strength information and displays it to the user in a known manner. Accordingly, the user can monitor the signal strength as displayed on the LCD Display 105 to manually adjust the location of the network interface 100 in order to maximize the signal strength.

A wireless network card 125 is connected to the CPU 135. The wireless network card 125 is connected to the CPU 135 via a mini-PCI connector (not shown). The wireless network card 125 allows the network adapter 100 to access any one of available wireless networks. The wireless network card can transmit the information to the network by implementing a variation of the IEEE 802.11 standard, however, one of ordinary skill can appreciate that other methods can be employed as well. The wireless network card 125 is built into the network adapter via a replaceable module via a known standard such as PCI, PCMIA or USB. By employing a particular wireless card, a user can have access to any number of wireless networks such as Wi-Fi, Wi-Max, EV-DO, HSPDA and any other wireless network for which a mini-PCI card has been developed.

One of ordinary skill in the art can appreciate that the network adapter 100 requires AC or DC power in order to operate. As way of example and not limitation, the network adapter can be powered from an AC electrical outlet or DC power source, such as the cigarette lighter in an automobile or a DC battery.

In yet another embodiment of the invention, the network adapter 100 can be adapted to include multiple wireless network cards. The multiple wireless network cards feature would allow the user flexiblity to employ different types of wireless network services, such as Wi-Fi and cellular broadband wireless. One of ordinary skill can appreciate that many different services can be employed and the example is used for illustration and not as a way of limitation. The circuitry would be adapted to include a mini-PCI card and another mini-PCI card or other replaceable module, such as PCMIA, USB or PCI. The CPU 135 would include software which would allow the network interface to adaptively switch between using the wireless network cards to transmit a voice signal and allow a user to replace wireless network cards during the operation of the network adapter 100. For example, when the network adapter 100 is not in range of the router 235 via Wi-Fi or other wireless network, the network adapter 100 would transmit the packetized voice signal from the phone via a broadband cellular network like EV-DO or other applicable cellular broadband network to which the user has a subscription.

The network adapter 100 has the capability to be attached to a local area network 150 to communicate with users on laptop or desktop personal computers and a wide area/broadband network 155 for communicating over a packet switched network, such as the Internet. Typically, the network adapter has one or more RJ-11 jacks to connect with a telephone, and at least one RJ-45 connection to a 10/100BaseT Ethernet Hub or switch to connect to the local area network 150.

Also, connected to the CPU 135 is a cellular chip 130 implementing a transceiver which allows the network adapter 100 to access a cellular network. The cellular chip 130 receives voice data from the CPU and modulates and transmits the data in a known way as to communicate with another user on the celluar network. The cellular chip 130 functions in a duplex manner as to allow voice conversations over the cellular network.

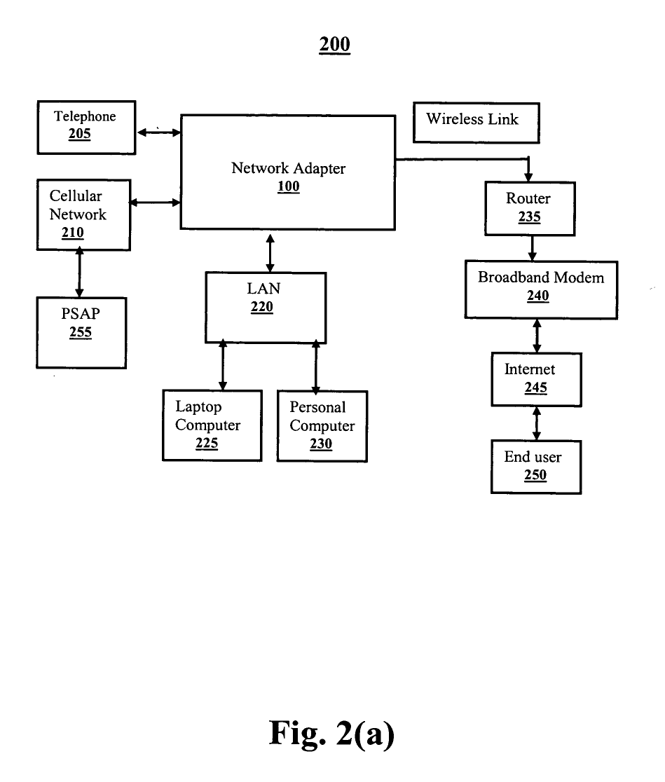

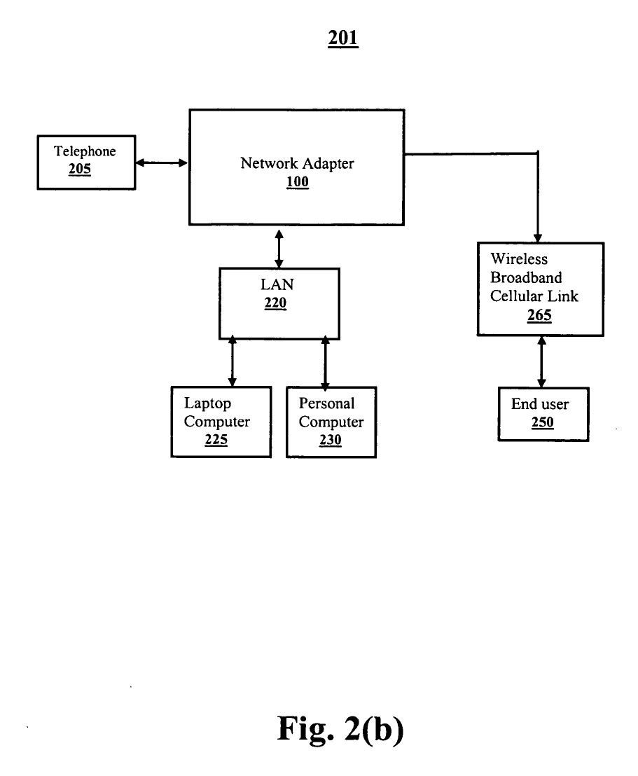

FIG. 2(a) illustrates a communications network 200, according to an embodiment of the invention. The communications network 200 includes a telephone 205, cellular network 210, network adapter 100, local area network (LAN) 220, laptop computer 225, personal computer 230, router 235, a broadband modem 240, Internet 245, end-user 250, and public safety answering point (PSAP) 255.

According to an embodiment of the invention, the network adapter 100 includes a wireless network card 125 which allows the analog phone adapter 100 to wirelessly connect to a wide area network, such as the Internet 245. As shown in FIG. 2, the network adapter 100 would transmit digitized voice signals to a router 235. The router 235 is of a kind well known by those of ordinary skill in the art, such as 802.11g routers. The router 235 would receive the voice signal and convert it into a packet format for transmission over the Internet 245. Accordingly, the network adapter 100 need not be physically connected to the router 235 and therefore does not have to be in close physical proximity to the router 235.

The network adapter can receive voice inputs from a telephone 205, or from a laptop computer 225 or personal computer 230 via a LAN 220.

As stated above and with reference to FIG. 1, the network adapter 100 includes a wireless network card 125. The wireless network card 125 is of a kind known to one of ordinary skill in the art, such 802.11b and 802.11g PCI cards. The wireless network card 125 in the network adapter 100 can be configured to transmit the digitized voice data across several different networks. One of ordinary skill in the art can appreciate that there are numerous types of wireless PCI cards allowing access to numerous networks, such as Wi-Fi, Wi-Max, EV-DO and HSPDA and others.

The router 235 transmits the digitized voice signal to the broadband modem 240. Devices such as routers act as access points, or portals, to a packet switched network, such as the Internet. The broadband modem 240 encodes and transmits the digitized voice signal across a packet switched network such as the Internet 245. The broadband modem 240 can be cable modem, DSL modem, or satellite or other wireless broadband link. One of ordinary skill in the art can appreciate that the router 235 could be a stand-alone router for a home user or a server in an enterprise setting.

The transmitted digitized voice signals are received and decoded and converted to analog voice signals by end user 250 at the far-end.

The network adapter 100 also includes a cellular chip 130 which is used for diverting emergency 911 calls from the VoIP system. When the network adapter 100 detects an emergency call, the CPU 135 diverts the call to the cellular chip 130 for transmission over a cellular network. The PSAP 255 receives the call and processes the call.

The embodiment shown in FIG. 2 is provided for illustration purposes and not by way of limitation. It will be apparent to one of ordinary skill in the art that the elements that make up the communications network can vary and be optimized for different applications.

FIG. 2(b) illustrates a communications network 201, according to an embodiment of the invention. The communications network 201 includes a telephone 205, network adapter 100, local area network (LAN) 220, laptop computer 225, personal computer 230, broadband cellular link 265 and end-user 250. According to one embodiment of the invention, the network adapter 100 is being employed in a broadband communications network such as Evolution Data Optimized (EV-DO) and other similar systems. One of ordinary skill in the art can appreciate that the description is for illustrative purposes and not for limitation.

The network adapter 100 allows a user either via a telephone 205 or a laptop computer 225 or desktop computer 230 via the LAN 220 to transmit wireless data via a broadband cellular network. The digitized voice signal is applied to the wireless network card 125 via the CPU 135. The wireless network card 125 would be of a type which would allow access to a broadband cellular network. The wireless network card 125 would transmit the voice data in data packets using a code division multiple access (CDMA) scheme, or whatever packet data communications protocol is being used on that broadband network. The voice signal data would be transmitted along a broadband celluar link 265 to the end-user 250.

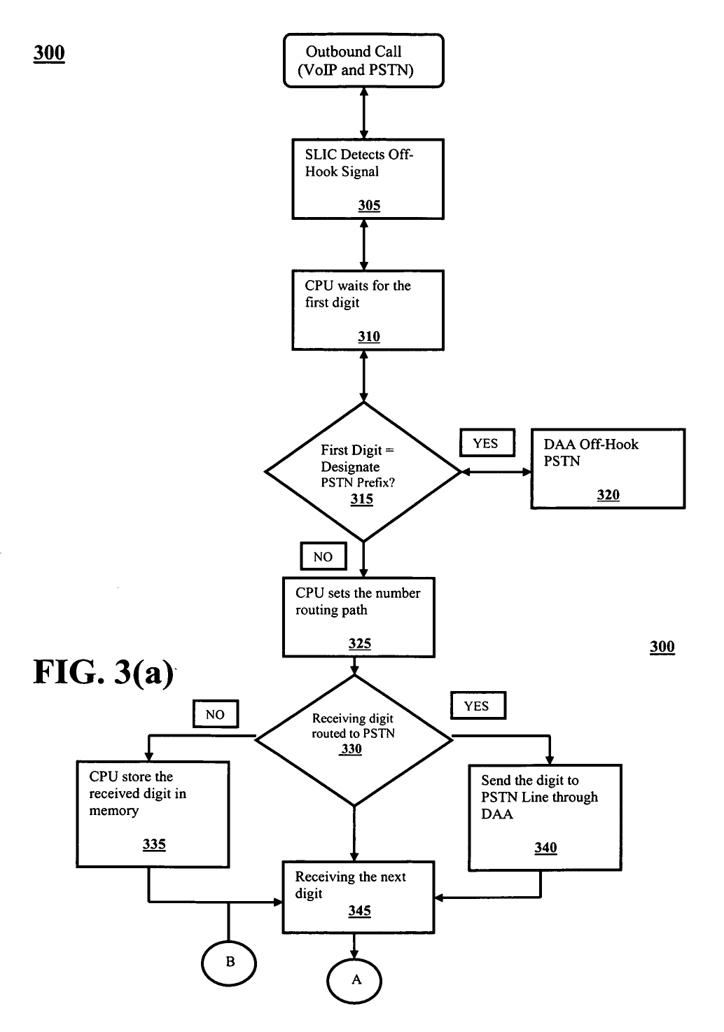

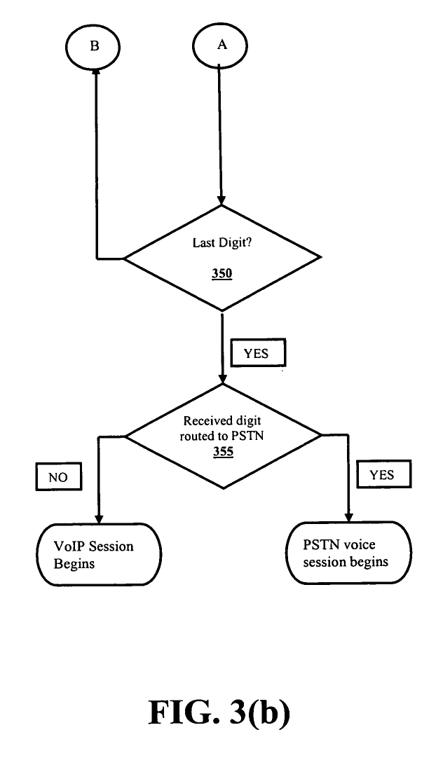

FIG. 3 illustrates a flow diagram of method 300 of the call flow of a user making an outbound telephone call, in accordance with an embodiment of the invention. The method 300 is described with respect to the network adapter 100 shown in FIG. 1, but may be applied to other systems.

In step 305, the SLIC 140 detects an off-hook condition and notifies the CPU 135. In step 310, the DSP (not shown) in the CPU 135 awaits the receipt of the first dual-tone multi-frequency (DTMF) digit from the handset. In step 315, if the CPU 135 determines from the first digit that the call is to be placed over the relay 160, then the CPU 135 instructs the DAA 145 to go off-hook, as shown in step 320.

In step 325, the DSP software in the CPU 135 handles the DTMF digits differently depending on whether the call is a VoIP or PSTN call. The routing number path is changed based on whether the call is a VoIP or PSTN call.

In step 330, the method 300 determines if the call should be routed to the PSTN. In step 335, if the DSP software determines the call to be a VoIP call, then the digits are obtained in a loop or stored into the flash memory buffer 110. In step 340, if the DSP software determines the call to be a PSTN call, then the digits are obtained in a loop and transferred to the DAA 145 and then transferred to the central office of the local telephone company (not shown).

In step 345, the next DTMF digit is received and the method receives the DTMF digits until the last digit has been received in step 350, which is determined either by a timeout value exceeded while awaiting the digit or by the user pressing the pound key. In step 355, the method 300 determines whether the last digit has been routed to the PSTN. In the case of a PSTN call, the DAA 145 processes the real time conversion of the analog and digital signal and the call is considered up. In the case of a VoIP voice call, the CPU 135 generates and receives the appropriate messages via WAN 155 based on whatever protocol is used to place the VoIP call. Based on which status message is generated by the far-end analog telephone adapter or VoIP phone (not shown), the CPU 135 produce the appropriate tones to emulate a ringing tone, a busy tone, network congestion tone, etc.

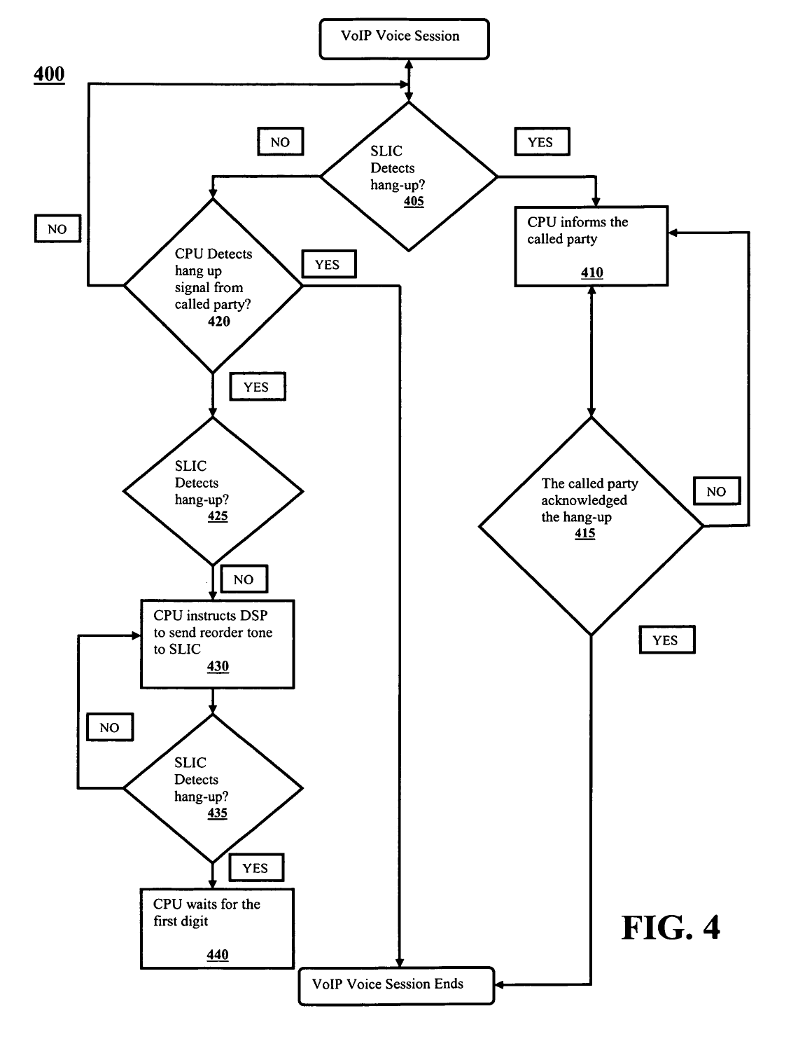

FIG. 4 illustrates a flow diagram of method 400 of the end of a VoIP call, in accordance with an embodiment of the invention. The method 400 is described with respect to the network adapter 100 shown in FIG. 1, but may be applied to other systems.

In step 405, the CPU 135 is waiting to detect that the SLIC 140 has detected a hang-up (on-hook) status from the handset or a termination message from the far-end. If as in step 410, the CPU 135 receives a hang-up acknowledgement from the SLIC 140, then it sends a termination message to the far-end and waits for the far-end to acknowledge it. In step 415, once the far-end acknowledges the termination, the call is considered ended and the voice session ends.

If as in step 420, a hang-up signal is not detected from the far-end handset, the CPU 135 checks whether a termination has been received from the far-end. In step 425, if the CPU received a hang-up signal from the called party, then the CPU 135 waits to detect a notification from SLIC 140 that the far-end handset has gone off-hook. Upon notification of the hang-up signal from the SLIC 140, the call is considered over and the voice session ends.

In step 430, after waiting a predetermined amount of time for the hang-up signal, the DSP in the CPU 135 will generate a re-order tone and transmit the tone to the SLIC 140. The re-order tone is to notify the user that the call has been terminated by the far-end and he needs to hang up the handset. In step 435, the CPU is waiting to detect a notification signal from SLIC 140 that the far-end handset has gone off-hook. In step 440, once the CPU 135 gets notification that the user went off-hook, the CPU 135 stops the re-order tone and the call is considered over and the voice session ends.

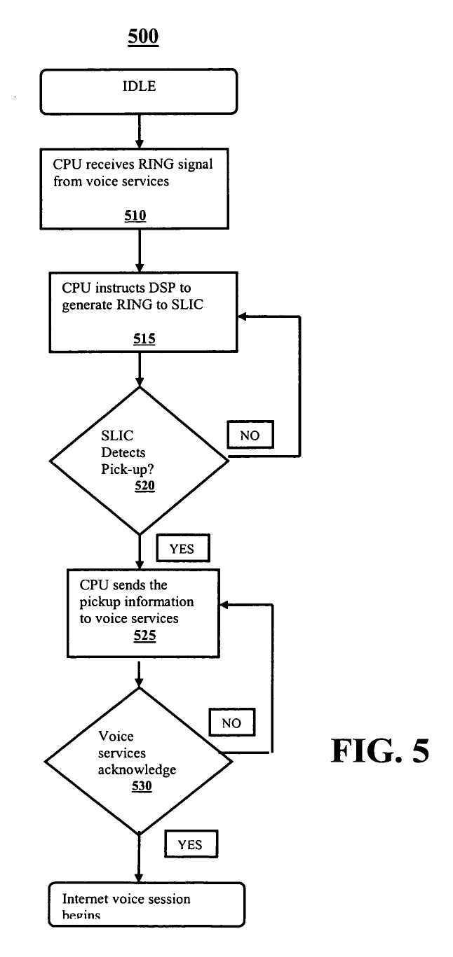

FIG. 5 illustrates a flow diagram of method 500 of the call flow of the beginnning of a VoIP call, in accordance with an embodiment of the invention. The method 500 is described with respect to the network adapter 100 shown in FIG. 1, but may be applied to other systems.

In step 510, the CPU 135 receives RING signals from voice services. The analog telephone adapter receives a message via the broadband modem 240 from a far-end user indicating that they wanted to initiate a call. In step 515, the CPU 135 instructs the DSP to generate ring tone to the SLIC 140 which generates ring current to be sent to the handset (not shown). In step 520, the SLIC 140 waits for the handset to go off-hook. In step 525, once the handset is determined to be off-hook, the CPU 135 sends a notification message to the far-end. In step 530, the CPU awaits the acknowledgement from voice services on the far-end. Upon receiving the acknowledgement, the internet voice session begins and both parties can begin to stream voice.

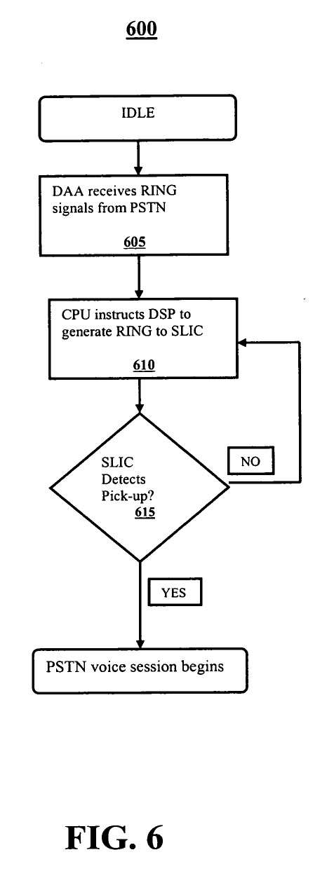

FIG. 6 illustrates a flow diagram of method 600 of the call flow of a call initated by the PSTN, in accordance with an embodiment of the invention. The method 600 is described with respect to the network adapter 100 shown in FIG. 1, but may be applied to other systems.

In step 605, the network adapter 100 via the DAA 145 receives a message via the broadband modem 240 indicating that someone desires to initiate a call. In step 610, the CPU 135 instructs the DSP to generate a ring tone to the SLIC 140 which causes ring current to be sent to the handset. In step 615, the CPU 135 waits for the handset to go off-hook. Once the handset goes off-hook the CPU sends a notification message to the far-end and both parties can begin to stream voice and the PSTN voice session begins.

In another embodiment of the invention, the network adapter 100 is used to make an emergency call. In prior art systems, there were numerous difficulties in making a 911 call or other emergency call using VoIP technology. For example, the VoIP service did not connect to the 911 service. Moreover, emergency calls made with VoIP service would not include caller-id information indicating the location of the caller, an often important piece of information in an emergency situation. In order to overcome the above stated difficulties, the network adapter can be configured to transfer an emergency call to the PSTN server in order to circumvent the problems associated with using the VoIP server.

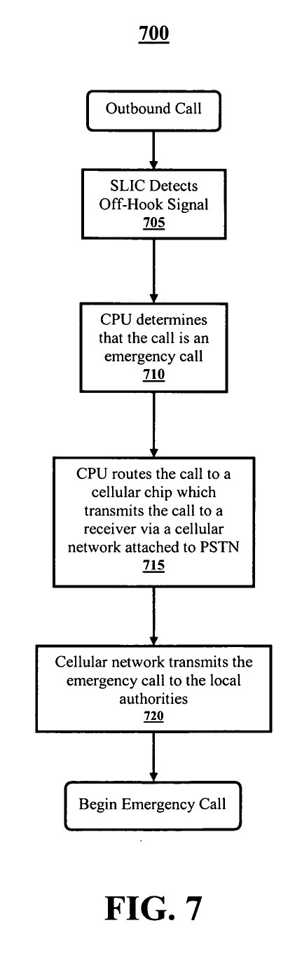

FIG. 7 illustrates a flow diagram of method 700 of the call flow of an emergency call, in accordance with an embodiment of the invention. The method 700 is described with respect to the network adapter 100 shown in FIG. 1, but may be applied to other systems.

In step 705, the SLIC 140 detects an off-hook condition and notifies the CPU 135. The DSP (not shown) embedded in the CPU 135 awaits the receipt of the first DTMF digit from the handset. In step 710, the CPU 135 determines that the call is to be an emergency call. This is determined by the user inputting known DTMF digits according to emergency services, such as 911 call, 311 call and other services known to one of ordinary skill in the art.

In step 715, the CPU 135 routes the call to a cellular chip 130 which transmits the call to a receiver via a celluar network 210. The cellular network circuit acts to modulate the voice signal in a manner which allows it to be transmitted over a cellular network. It will be apparent to one of ordinary skill in the art that there are numerous ways to implement a cellular network, such as GSM, CDMA, UMTS and the embodiment provided is not meant to limit the scope of the invention.

In step 720, the cellular network transmits the emergency call to the appropriate public safety answering point (PSAP) in a way known to one of ordinary skill in the art. Once the call has been connected to the PSAP, the emergency call begins over the PSTN and cellular network.

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention, which is intended to be defined by the following claims, in which all terms are meant in their broadest reasonable sense unless otherwise indicated therein.

We claim:

1. A network adapter for connecting a device to a Voice Over Internet Protocol (VoIP) compatible communications network comprising:
a processor;
a relay device, coupled to the processor, for connecting a telephone device to the network adapter; and
a wireless network card, coupled to the processor, for wirelessly communicating voice data.

2. A method for providing wireless access to a network access point coupled to a packet switched network comprising the steps of:
detecting an OFF hook signal;
determining which of a plurality of networks, including a wireless network, a voice signal is to be applied to;
connecting to said wireless network; and
transmitting voice signal data via the wireless network.

3. A system for transmitting voice signals over a packet switched network comprising:
a network adapter having a wireless transceiver which can access a wireless network;
a network device, for receiving voice signal data transmitted from the network adapter; and
a server device, coupled to the network device, for transmitting received voice signal data over a packet switched network.

4. A method for transmitting voice signals over a packet switched network comprising the steps of:
transmitting a digitized voice signal over a wireless network;
receiving the digitized voice signal, at a portal to a packet switched network; and
communicating with a server, such that the digitized voice signal is transmitted over the packet switched network via the server.

5. A computer-usable storage medium having computer readable instructions stored thereon for execution by a processor to perform a method comprising the steps of:
detecting an OFF hook signal;
determining which of a plurality of networks, including a wireless network, a voice signal is to be applied to;
connecting to said wireless network; and
transmitting voice signal data via the wireless network.

6. A network adapter for connecting a user employing a VoIP service to a public safety answering point, comprising:
a central processing unit;
a relay device, coupled to the central processing unit, for connecting a telephone device to the network adapter; and
a wireless network interface device, coupled to the central processing unit, for accessing a cellular network and transmitting call data to a public safety answering point via the cellular network.

7. A method for providing access to a public safety answering point for a user of a VoIP service:
detecting an off-hook signal at a network adapter coupled to a plurality of different types of networks;
determining that the call is an emergency call; and
routing the emergency call to a network coupled to said network adapter other than said wireless network, which is capable of transmitting calling party location information.

8. A computer-usable storage medium having computer readable instructions stored thereon for execution by a processor to perform a method comprising:
detecting an off-hook signal at a network adapter coupled to a plurality of different types of networks;
determining that the call is an emergency call; and
routing the emergency call to a network coupled to said network adapter other than said wireless network, which is capable of transmitting calling party location information.

9. A system for transmitting voice signals over a broadband cellular network comprising:
a network adapter having a plurality of different types of network interfaces, including a cellular network interface which can access a broadband cellular network;
wherein said network adapter is capable of receiving voice signal data from a telephone device and communicating said data to a cellular link coupled to said broadband cellular network.
